(19) United States
(12) Patent Application Publication
(10) Pub. No.: US 2026/0171027 A1
(43) Pub. Date: Jun. 18, 2026

(54) SHIFT REGISTER UNIT, DRIVE CONTROL CIRCUIT, DISPLAY APPARATUS , AND DRIVE METHOD

(71) Applicants: Chengdu BOE Optoelectronics Technology Co. Ltd., Chengdu, Sichuan Province (CN); BOE Technology Group Co., Ltd., Beijing (CN); Beijing BOE Technology Development Co. Ltd., Beijing (CN)

(72) Inventors: Yao HUANG, Beijing (CN); Mengmeng DU, Beijing (CN); Xiangdan DONG, Beijing (CN); Ming HU, Beijing (CN); Haijun QIU, Beijing (CN); Dongfang YANG, Beijing (CN)

(21) Appl. No.: 18/711,696

(22) PCT Filed: Aug. 11, 2023
(86) PCT No.: PCT/CN2023/112706

§ 371 Date: May 20, 2024

(51) Int. Cl. G09G 3/3266

(52) U.S. Cl. CPC G09G 3/3266; G09G 2300/0408; G09G 2310/0286; G09G 2310/06; G09G 2310/08; G09G 2330/04

(57) ABSTRACT

The disclosure provides a shift register unit, a drive control circuit, a display apparatus, and a drive method. The shift register unit includes: an input circuit coupled to a first node and configured to provide a signal of an input signal terminal to the first node in response to a signal of a first clock signal terminal; a control circuit coupled to the first node, a second node, a control signal terminal, and a first reference signal terminal and configured to provide the signal of the first clock signal terminal and a signal of the first reference signal terminal to a third node and the second node, respectively, in response to a signal of the first node, where the first node is not controlled by the second node or the third node; and an output circuit coupled to the first node and the second node.

### CROSS REFERENCE TO RELATED APPLICATIONS

The present disclosure is a national phase entry under 35 U.S. C § 371 of International Application No. PCT/CN 2023/112706, filed Aug. 11, 2023, and the entire content of which is incorporated herein by reference.

### TECHNICAL FIELD

The disclosure relates to the field of display technologies, and particularly relates to a shift register unit, a drive control circuit, a display apparatus, and a drive method.

### BACKGROUND

As the display technology develops rapidly, display apparatuses have a growing tendency to high integration density and low cost. With the gate driver on array (GOA) technology, a thin film transistor (TFT) drive control circuit is integrated with an array substrate of a display apparatus, so as to drive the display apparatus. The drive control circuit is generally composed of a plurality of cascaded shift register units. However, output of the shift register units is unstable, which will lead to abnormal display.

### SUMMARY

The disclosure provides a shift register unit, a drive control circuit, a display apparatus, and a drive method, and specific solutions are as follows.

Embodiments of the disclosure provide a shift register unit. The shift register unit includes:
an input circuit, coupled to a first node and configured to provide, in response to a signal of a first clock signal terminal, a signal of an input signal terminal to the first node;
a control circuit, coupled to the first node, a second node, a control signal terminal, and a first reference signal terminal and configured to provide, in response to a signal of the first node, the signal of the first clock signal terminal and a signal of the first reference signal terminal to a third node and the second node, respectively, where the first node is not controlled by the second node or the third node; and
an output circuit, coupled to the first node and the second node and configured to provide, in response to a signal of the second node, the signal of the first reference signal terminal to an output signal terminal and to provide, in response to the signal of the first node, a signal of a second reference signal terminal to the output signal terminal.

Optionally, in the embodiments of the disclosure, the control circuit includes a first control module, a second control module, and a third control module;
the first control module is coupled to the first node and the third node, and is configured to provide, in response to the signal of the first node, the signal of the first clock signal terminal to the third node and to provide, in response to the signal of the first clock signal terminal, a signal of the control signal terminal to the third node;
the second control module is coupled to the second node and the third node, and is configured to provide, in response to a signal of the third node and a signal of a second clock signal terminal, the signal of the second clock signal terminal to the second node; and
the third control module is coupled to the first node and the second node, and is configured to provide, in response to the signal of the first node, the signal of the first reference signal terminal to the second node.

Optionally, in the embodiments of the disclosure, the shift register unit further includes a voltage stabilizing circuit; and the voltage stabilizing circuit is coupled to the third node, and is configured to maintain potential of the third node.

Optionally, in the embodiments of the disclosure, the voltage stabilizing circuit includes a first capacitor; a first electrode of the first capacitor is coupled to the third node, and a second electrode of the first capacitor is coupled to the second reference signal terminal.

Optionally, in the embodiments of the disclosure, the shift register unit further includes a protection circuit; the third node is coupled to the second control module via the protection circuit; and the protection circuit is configured to control connection and disconnection between the third node and the second control module.

Optionally, in the embodiments of the disclosure, the control signal terminal and the first clock signal terminal are the same signal terminal.

Optionally, in the embodiments of the disclosure, the control signal terminal and the second reference signal terminal are the same signal terminal.

Optionally, in the embodiments of the disclosure, the input circuit includes a first transistor; a gate electrode of the first transistor is coupled to the first clock signal terminal, a first electrode of the first transistor is coupled to the first node, and a second electrode of the first transistor is coupled to the input signal terminal.

Optionally, in the embodiments of the disclosure, the first control module includes a second transistor and a third transistor;
a gate electrode of the second transistor is coupled to the first node, a first electrode of the second transistor is coupled to the first clock signal terminal, and a second electrode of the second transistor is coupled to the third node; and
a gate electrode of the third transistor is coupled to the first clock signal terminal, a first electrode of the third transistor is coupled to the third node, and a second electrode of the third transistor is coupled to the control signal terminal.

Optionally, in the embodiments of the disclosure, the second control module includes a fourth transistor and a fifth transistor;
a gate electrode of the fourth transistor is coupled to the third node; a first electrode of the fourth transistor is coupled to a fourth node, and a second electrode of the fourth transistor is coupled to the second clock signal terminal; and
a gate electrode of the fifth transistor is coupled to the second clock signal terminal, a first electrode of the fifth transistor is coupled to the second node, and a second electrode of the fifth transistor is coupled to the fourth node.

Optionally, in the embodiments of the disclosure, the shift register unit further includes a reset circuit. The reset circuit is coupled to the first node and a fourth node, and is configured to provide, in response to a signal of the fourth node, the signal of the first reference signal terminal to the first node.

Optionally, in the embodiments of the disclosure, the third control module includes a sixth transistor; a gate electrode of the sixth transistor is coupled to the first node, a first electrode of the sixth transistor is coupled to the first reference signal terminal, and a second electrode of the sixth transistor is coupled to the second node.

Optionally, in the embodiments of the disclosure, the output circuit includes a seventh transistor, a second capacitor, an eighth transistor, and a third capacitor;
a gate electrode of the seventh transistor is coupled to the second node, a first electrode of the seventh transistor is coupled to the output signal terminal, and a second electrode of the seventh transistor is coupled to the first reference signal terminal;
a first electrode of the second capacitor is coupled to the second node, and a second electrode of the second capacitor is coupled to the first reference signal terminal;
a gate electrode of the eighth transistor is coupled to the first node, a first electrode of the eighth transistor is coupled to the second reference signal terminal, and a second electrode of the eighth transistor is coupled to the output signal terminal; and
a first electrode of the third capacitor is coupled to the first node and a second electrode of the third capacitor is coupled to the output signal terminal.

Optionally, in the embodiments of the disclosure, the protection circuit includes a ninth transistor; a gate electrode of the ninth transistor is coupled to the second reference signal terminal, a first electrode of the ninth transistor is coupled to a gate electrode of a fourth transistor, and a second electrode of the ninth transistor is coupled to the third node.

Optionally, in the embodiments of the disclosure, the reset circuit includes a tenth transistor; and a gate electrode of the tenth transistor is coupled to the fourth node, and a first electrode of the tenth transistor is coupled to the first node and a second electrode of the tenth transistor is coupled to the first reference signal terminal.

Accordingly, the embodiments of the disclosure provide a shift register unit. The shift register unit includes:
a first transistor, where a first electrode of the first transistor is directly connected to a first node;
a second transistor, where a gate electrode of the second transistor is directly connected to the first node, and a second electrode of the second transistor is coupled to a third node;
a sixth transistor, where a gate electrode of the sixth transistor is directly connected to the first node, and a second electrode of the sixth transistor is coupled to a second node; and
an eighth transistor, where a gate electrode of the eighth transistor is directly connected to the first node, a first electrode of the eighth transistor is coupled to a second reference signal terminal, and a second electrode of the eighth transistor is coupled to an output signal terminal; the first node is not controlled by the second node or the third node.

Optionally, in the embodiments of the disclosure, the shift register unit further includes:
a first capacitor, where a first electrode of the first capacitor is coupled to the third node, and a second electrode of the first capacitor is coupled to the second reference signal terminal.

Optionally, in the embodiments of the disclosure, the shift register unit further includes a ninth transistor; and a gate electrode of the ninth transistor is coupled to the second reference signal terminal, and a second electrode of the ninth transistor is coupled to the third node.

Optionally, in the embodiments of the disclosure, the shift register unit further includes a tenth transistor; and a gate electrode of the tenth transistor is coupled to a fourth node, a first electrode of the tenth transistor is coupled to the first node, and a second electrode of the tenth transistor is coupled to a first reference signal terminal.

Optionally, in the embodiments of the disclosure, the shift register unit further includes:
a third transistor, where a first electrode of the third transistor is coupled to the third node, and a second electrode of the third transistor is coupled to a control signal terminal;
a fourth transistor, where a gate electrode of the fourth transistor is coupled to the third node, and a first electrode of the fourth transistor is coupled to a fourth node;
a fifth transistor, where a first electrode of the fifth transistor is coupled to the second node, and a second electrode of the fifth transistor is coupled to the fourth node;
a seventh transistor, where a gate electrode of the seventh transistor is coupled to the second node, and a first electrode of the seventh transistor is coupled to the output signal terminal;
a second capacitor, where a first electrode of the second capacitor is coupled to the second node, and a second electrode of the second capacitor is coupled to a first reference signal terminal; and
a third capacitor, where a first electrode of the third capacitor is coupled to the first node, and a second electrode of the third capacitor is coupled to the output signal terminal.

Optionally, in the embodiments of the disclosure, a gate electrode of the first transistor is coupled to a first clock signal terminal, and a second electrode of the first transistor is coupled to an input signal terminal;
a first electrode of the second transistor is coupled to the first clock signal terminal;
a gate electrode of the third transistor is coupled to the first clock signal terminal;
a second electrode of the fourth transistor is coupled to a second clock signal terminal;
a gate electrode of the fifth transistor is coupled to the second clock signal terminal;
a first electrode of the sixth transistor is coupled to the first reference signal terminal;
a second electrode of the seventh transistor is coupled to the first reference signal terminal; and
a second electrode of the eighth transistor is coupled to the output signal terminal.

Optionally, in the embodiments of the disclosure, the control signal terminal and the first clock signal terminal are the same signal terminal.

Optionally, in the embodiments of the disclosure, the control signal terminal and the second reference signal terminal are the same signal terminal.

Accordingly, the embodiments of the disclosure provide a drive control circuit. The drive control circuit includes:
a plurality of cascaded shift register units according to any one of the above embodiments;
an input signal terminal of a first stage shift register unit is coupled to a frame triggering signal terminal; and
in every two adjacent shift register units, an input signal terminal of a next stage shift register unit is coupled to an output signal terminal of a previous stage shift register unit.

Accordingly, the embodiments of the disclosure provide a display apparatus. The display apparatus includes: the drive control circuit mentioned above.

Accordingly, the embodiments of the disclosure provide a drive method for the shift register unit according to any one of the above embodiments. The drive method includes:
in a first stage, providing, by an input circuit, a signal of an input signal terminal to a first node in response to a signal of a first clock signal terminal; providing, by a control circuit, the signal of the first clock signal terminal and a signal of a first reference signal terminal to a third node and a second node, respectively, in response to a signal of the first node, and controlling potential of the second node to be opposite to that of the first node; and providing, by an output circuit, a signal of a second reference signal terminal to an output signal terminal in response to the signal of the first node.

### BRIEF DESCRIPTION OF FIGURES

FIG. 1 is a schematic structural diagram of a shift register unit in the related art.

FIG. 2 is a schematic diagram of a simulation waveform of voltage of each node of the shift register unit shown in FIG. 1 in a working state.

FIG. 3 is a schematic structural diagram of a shift register unit according to an embodiment of the disclosure.

FIG. 4 is another schematic structural diagram of a shift register unit according to an embodiment of the disclosure.

FIG. 5 is yet another schematic structural diagram of a shift register unit according to an embodiment of the disclosure.

FIG. 6 is yet another schematic structural diagram of a shift register unit according to an embodiment of the disclosure.

FIG. 7 is a signal timing diagram according to an embodiment of the disclosure.

FIG. 8 is yet another schematic structural diagram of a shift register unit according to an embodiment of the disclosure.

FIG. 9 is yet another schematic structural diagram of a shift register unit according to an embodiment of the disclosure.

FIG. 10 is yet another schematic structural diagram of a shift register unit according to an embodiment of the disclosure.

FIG. 11 is yet another schematic structural diagram of a shift register unit according to an embodiment of the disclosure.

FIG. 12 is yet another schematic structural diagram of a shift register unit according to an embodiment of the disclosure.

FIG. 13 is yet another schematic structural diagram of a shift register unit according to an embodiment of the disclosure.

FIG. 14 is yet another schematic structural diagram of a shift register unit according to an embodiment of the disclosure.

FIG. 15 is yet another schematic structural diagram of a shift register unit according to an embodiment of the disclosure.

FIG. 16 is yet another schematic structural diagram of a shift register unit according to an embodiment of the disclosure.

FIG. 17 is still another schematic structural diagram of a shift register unit according to an embodiment of the disclosure.

FIG. 18 is a schematic structural diagram of a drive control circuit according to an embodiment of the disclosure.

FIG. 19 is a flow diagram of a drive method for a shift register unit according to an embodiment of the disclosure.

### DETAILED DESCRIPTION

For making objectives, technical solutions and advantages of embodiments of the disclosure clearer, the technical solutions of the embodiments of the disclosure will be clearly and completely described below in conjunction with the drawings in the embodiments of the disclosure. Apparently, the embodiments described are some embodiments rather than all embodiments of the disclosure. The embodiments in the disclosure and features of the embodiments may be combined with each other without conflict. Based on the embodiments of the disclosure, all other embodiments obtained by those of ordinary skill in the art without making creative efforts fall within the protection scope of the disclosure.

Unless otherwise defined, technical or scientific terms used in the disclosure should have ordinary meanings as understood by those of ordinary skill in the art to which the disclosure belongs. “First”, “second”, and other similar words used in the disclosure do not indicate any order, amount or importance, but are only used to distinguish different components. “Include”, “comprise”, “involve” and other similar words indicate that elements or objects before the word include elements or objects after the word and their equivalents, without excluding other elements or objects. “Connect”, “connected”, and other similar words are not limited to physical or mechanical connections, but may include electrical connections, which may be direct or indirect. “Inside”, “outside”, “upper”, “lower”, etc. are only used to indicate a relative positional relation. After an absolute position of the described object changes, the relative positional relation may also change accordingly.

It should be noted that a size and a shape of each figure in the drawings do not reflect a true scale, but only for illustrating contents of the disclosure. Throughout the drawings, identical or similar reference numerals denote identical or similar elements or elements having identical or similar functions.

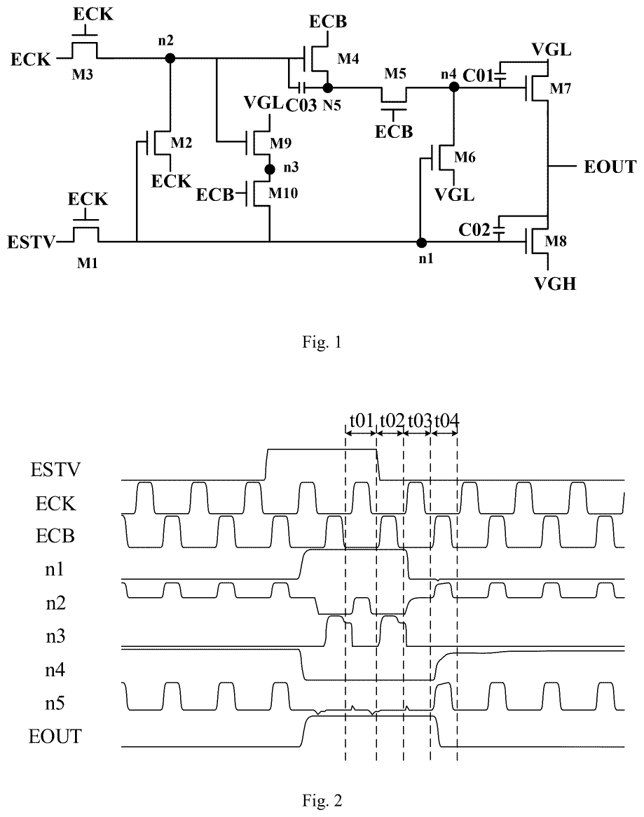

In the related art, as shown in FIGS. 1 and 2, FIG. 1 is a schematic structural diagram of a shift register unit in a light emitting drive circuit. The shift register unit includes transistors M1-M10 and capacitors C01-C03. FIG. 2 is a schematic diagram of a simulation waveform of voltage of each node of the shift register unit shown in FIG. 1 in a working state. At stage t04, potential of point n2 is increased by ecb, such that voltage of the point n2 is up to 35 V, and excessive bias voltage of M2, M3, M4 and M9 may be caused. For instance, VDS of M2 is up to 40 V and VGS of M4 is 19 V. Once bias voltages of the transistors are too great, device characteristic shift easily occurs, and further use performance of the light emitting drive circuit is influenced.

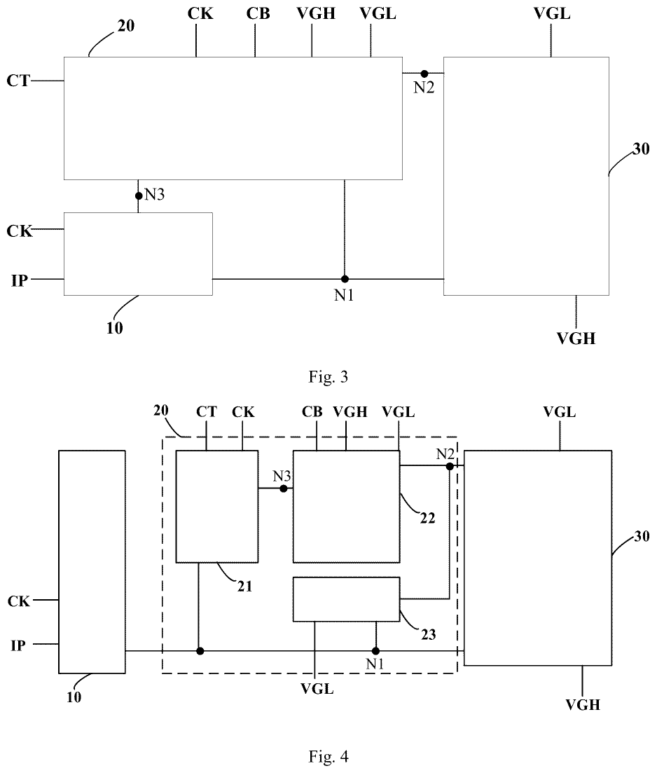

In view of that, embodiments of the disclosure provide a shift register unit. As shown in FIG. 3, the shift register unit includes:
an input circuit 10, coupled to a first node N1 and configured to provide, in response to a signal of a first clock signal terminal CK, a signal of an input signal terminal IP to the first node N1;
a control circuit 20, coupled to the first node N1, a second node N2, a control signal terminal CT, and a first reference signal terminal VGL and configured to provide, in response to a signal of the first node N1, the signal of the first clock signal terminal and a signal of the first reference signal terminal to a third node and the second node, respectively, where the first node is not controlled by the second node or the third node; and
an output circuit 30, coupled to the first node N1 and the second node N2 and configured to provide, in response to a signal of the second node N2, the signal of the first reference signal terminal VGL to an output signal terminal OT and to provide, in response to the signal of the first node N1, a signal of a second reference signal terminal VGH to the output signal terminal OT.

In the embodiments of the disclosure, the input circuit 10 controls the signal of the first node N1; the control circuit 20 controls a signal of the second node N2 and a signal of the third node N3, and the signal of the second node N2 or the third node N3 does not influence the signal of the first node N1; and the output circuit 30 controls a signal of the output signal terminal OT. The number of devices used in the entire shift register unit is small, circuit complexity is low, production cost is low, a circuit structure is simple, and an occupied area is small, which facilitate narrow frame design. Moreover, through mutual cooperation of the above devices, stability of the signal output by the output signal terminal OT can be improved.

In the embodiments of the disclosure, as shown in FIG. 4, the control circuit 20 includes a first control module 21, a second control module 22, and a third control module 23.

The first control module 21 is coupled to the first node N1 and the third node N3, and is configured to provide, in response to the signal of the first node N1, the signal of the first clock signal terminal CK to the third node N3 and to provide, in response to the signal of the first clock signal terminal CK, a signal of the control signal terminal CT to the third node N3.

The second control module 22 is coupled to the second node N2 and the third node N3, and is configured to provide, in response to a signal of the third node N3 and a signal of a second clock signal terminal CB, the signal of the second clock signal terminal CB to the second node N2.

The third control module 23 is coupled to the first node N1 and the second node N2, and is configured to provide, in response to the signal of the first node N1, the signal of the first reference signal terminal VGL to the second node N2.

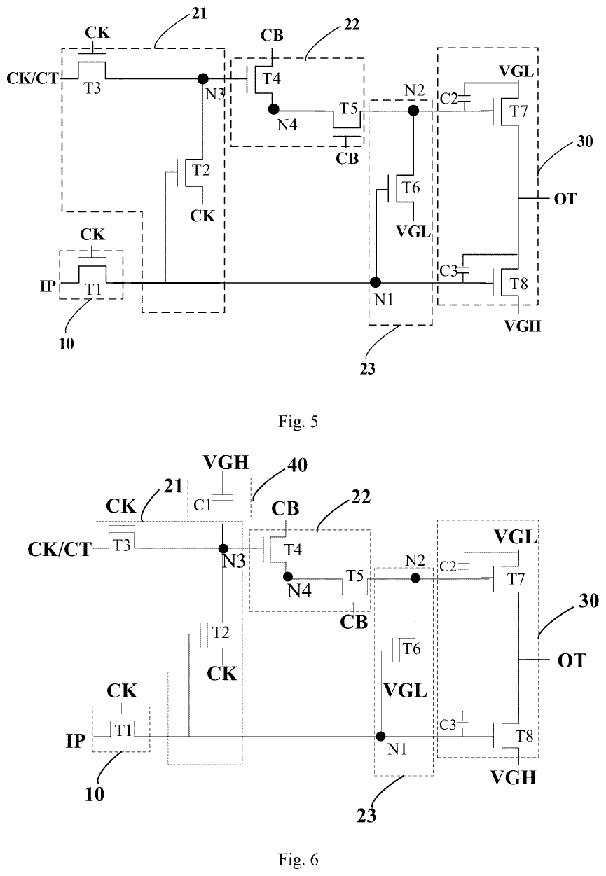

In the embodiments of the disclosure, as shown in FIG. 5, the control signal terminal CT and the first clock signal terminal CK are the same signal terminal. For instance, the control signal terminal CT and the first clock signal terminal CK may be coupled together, such that the number of signal lines can be reduced, and wiring difficulty can be reduced.

In the embodiments of the disclosure, as shown in FIG. 5, the input circuit 10 includes a first transistor T1.

A gate electrode of the first transistor T1 is coupled to the first clock signal terminal CK, a first electrode of the first transistor T1 is coupled to the first node N1, and a second electrode of the first transistor T1 is coupled to the input signal terminal IP.

During specific implementation, the first transistor T1 may be turned on under control of an effective level of a first clock signal transmitted by the first clock signal terminal CK, and may be turned off under control of an ineffective level of the first clock signal. For instance, if the first transistor T1 is set as an N-type transistor, the effective level of the first clock signal is a high level, and the ineffective level of the first clock signal is a low level. When the first transistor T1 is in an on state, the input signal terminal IP may be connected to the first node N1. When the first transistor T1 is in an off state, the input signal terminal IP may be disconnected from the first node N1.

In the embodiments of the disclosure, as shown in FIG. 5, the first control module 21 includes a second transistor T2 and a third transistor T3.

A gate electrode of the second transistor T2 is coupled to the first node N1, a first electrode of the second transistor T2 is coupled to the first clock signal terminal CK, and a second electrode of the second transistor T2 is coupled to the third node N3.

A gate electrode of the third transistor T3 is coupled to the first clock signal terminal CK, a first electrode of the third transistor T3 is coupled to the third node N3, and a second electrode of the third transistor T3 is coupled to the control signal terminal CT.

During specific implementation, the gate electrode of the second transistor T2 is coupled to the first node N1, such that the second transistor T2 may be turned on under control of an effective level of the signal transmitted by the first node N1, and may be turned off under control of an ineffective level of the signal transmitted by the first node N1. For instance, if the second transistor T2 is set as an N-type transistor, the effective level of the signal transmitted by the first node N1 is a high level, and the ineffective level of the signal transmitted by the first node N1 is a low level. When the second transistor T2 is in an on state, the first clock signal terminal CK may be connected to the third node N3. When the second transistor T2 is in an off state, the first clock signal terminal CK may be disconnected from the third node N3.

During specific implementation, the gate electrode of the third transistor T3 is coupled to the first clock signal terminal CK, such that the third transistor T3 may be turned on under control of an effective level of a first clock signal transmitted by the first clock signal terminal CK, and may be turned off under control of an ineffective level of the first clock signal. For instance, if the third transistor T3 is set as an N-type transistor, the effective level of the first clock signal is a high level, and the ineffective level of the first clock signal is a low level.

In the embodiments of the disclosure, as shown in FIG. 5, the second control module 22 includes a fourth transistor T4 and a fifth transistor T5.

A gate electrode of the fourth transistor T4 is coupled to the third node N3, a first electrode of the fourth transistor T4 is coupled to a fourth node N4 and a second electrode of the fourth transistor T4 is coupled to the second clock signal terminal CB.

A gate electrode of the fifth transistor T5 is coupled to the second clock signal terminal CB, a first electrode of the fifth transistor T5 is coupled to the second node N2, and a second electrode of the fifth transistor T5 is coupled to the fourth node N4.

During specific implementation, the fourth transistor T4 is turned on under control of an effective level of the signal transmitted by the third node N3, and is turned off under control of an ineffective level of the signal transmitted by the third node N3. For instance, if the fourth transistor T4 is set as an N-type transistor, the effective level of the signal transmitted by the third node N3 is a high level, and the ineffective level of the signal transmitted by the third node N3 is a low level. When the fourth transistor T4 is in an on state, the second clock signal terminal CB may be connected to the fourth node N4. When the fourth transistor T4 is in an off state, the second clock signal terminal CB may be disconnected from the fourth node N4.

During specific implementation, the fifth transistor T5 may be turned on under control of an effective level of a second clock signal provided by the second clock signal terminal CB, and may be turned off under control of an ineffective level of the second clock signal provided. For instance, if the fifth transistor T5 is set as an N-type transistor, the effective level of the second clock signal is a high level, and the ineffective level of the second clock signal is a low level.

In the embodiments of the disclosure, as shown in FIG. 5, the third control module 23 includes a sixth transistor T6.

A gate electrode of the sixth transistor T6 is coupled to the first node N1, a first electrode of the sixth transistor T6 is coupled to the first reference signal terminal VGL, and a second electrode of the sixth transistor T6 is coupled to the second node N2.

During specific implementation, the sixth transistor T6 is turned on under control of the effective level of the signal transmitted by the first node N1, and is turned off under control of the ineffective level of the signal transmitted by the first node N1. For instance, if the sixth transistor T6 is set as an N-type transistor, the effective level of the signal transmitted by the first node N1 is a high level, and the ineffective level of the signal transmitted by the first node N1 is a low level. When the sixth transistor T6 is in an on state, the first reference signal terminal VGL may be connected to the second node N2. When the sixth transistor T6 is in an off state, the first reference signal terminal VGL may be disconnected from the second node N2.

In the embodiments of the disclosure, as shown in FIG. 5, the output circuit 30 includes a seventh transistor T7, a second capacitor C2, an eighth transistor T8, and a third capacitor C3.

A gate electrode of the seventh transistor T7 is coupled to the second node N2, a first electrode of the seventh transistor T7 is coupled to the output signal terminal OT, and a second electrode of the seventh transistor T7 is coupled to the first reference signal terminal VGL.

A first electrode of the second capacitor C2 is coupled to the second node N2, and a second electrode of the second capacitor C2 is coupled to the first reference signal terminal VGL.

A gate electrode of the eighth transistor T8 is coupled to the first node N1, a first electrode of the eighth transistor T8 is coupled to the second reference signal terminal VGH, and a second electrode of the eighth transistor T8 is coupled to the output signal terminal OT.

A first electrode of the third capacitor C3 is coupled to the first node N1, and second electrode of the third capacitor C3 is coupled to the output signal terminal OT.

During specific implementation, the seventh transistor T7 is turned on under control of the effective level of the signal transmitted by the second node N2, and is turned off under control of the ineffective level of the signal transmitted by the second node N2. For instance, if the seventh transistor T7 is set as an N-type transistor, the effective level of the signal transmitted by the second node N2 is a high level, and the ineffective level of the signal transmitted by the second node N2 is a low level.

During specific implementation, the eighth transistor T8 is turned on under control of the effective level of the signal transmitted by the first node N1, and is turned off under control of the ineffective level of the signal transmitted by the first node N1. For instance, if the eighth transistor T8 is set as an N-type transistor, the effective level of the signal transmitted by the first node N1 is a high level, and the ineffective level of the signal transmitted by the first node N1 is a low level.

During specific implementation, according to a signal flow direction, the first electrodes of the transistors may be used as their sources, and the second electrodes of the transistors may be used as their drains; or the first electrodes of the transistors may be used as their drains, and the second electrodes of the transistors may be used as their sources, which are not specifically distinguished herein.

It should be noted that the transistor mentioned in the embodiments of the disclosure may be a thin film transistor (TFT) or a metal oxide semiconductor (MOS) field effect transistor, which is not limited herein.

In the embodiments of the disclosure, an active layer of each of the transistors may be a metal oxide semiconductor material. Accordingly, each transistor may be an N-type transistor using the metal oxide semiconductor material as the active layer. The first reference signal terminal VGL may be configured to load a constant first reference voltage, and the first reference voltage is generally negative, and for instance, −9 V. In addition, the second reference signal terminal VGH may load a constant second reference voltage, and the second reference voltage may be generally positive, and for instance, 7 V. In practical application, a specific value of the voltage may be designed and determined according to an actual application environment, which is not limited herein. In addition, the transistors may all be set as P-type transistors, which are not limited herein.

The embodiments of the disclosure further provide another schematic structural diagram of a shift register unit. As shown in FIG. 6, implementations in the above embodiments are modified. Only differences between the embodiment and the above embodiments will be described below, and similarities will not be repeated herein.

In the embodiments of the disclosure, as shown in FIG. 6, the shift register unit further includes a voltage stabilizing circuit 40. The voltage stabilizing circuit 40 is coupled to the third node N3, and is configured to maintain potential of the third node N3.

In an illustrative embodiment as shown in FIG. 6, the voltage stabilizing circuit 40 includes a first capacitor C1.

A first electrode of the first capacitor C1 is coupled to the third node N3, and a second electrode of the first capacitor C1 is coupled to the second reference signal terminal VGH.

During specific implementation, the first capacitor C1 may maintain the potential of the third node N3, such that the stability of the voltage of the third node N3 can be improved, and excessive bias voltage of the third node N3 can be effectively avoided.

In the embodiments of the disclosure, as shown in FIG. 6, the control signal terminal CT and the first clock signal terminal CK are the same signal terminal.

For instance, the control signal terminal CT and the first clock signal terminal CK may be coupled together, such that the number of signal lines can be reduced, and wiring difficulty can be reduced.

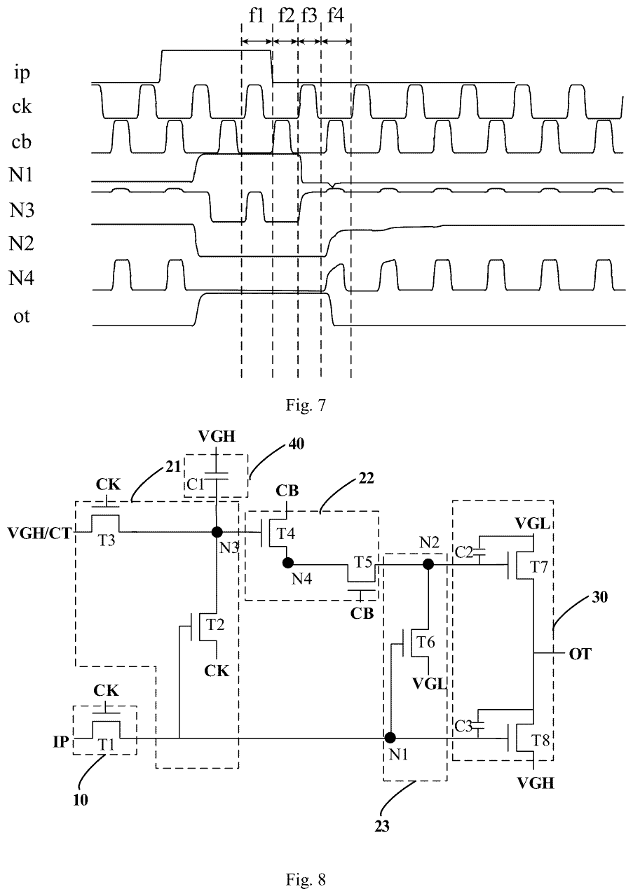

With the shift register unit shown in FIG. 6 as an instance, in combination with a signal sequence diagram shown in FIG. 7, a work process of the shift register unit according to the embodiments of the disclosure will be described below. In the following description, “1” denotes a high-level signal, “0” denotes a low-level signal, “ip” denotes an input signal of an input signal terminal IP, “ck” denotes a first clock signal of a first clock signal terminal CK, “cb” denotes a second clock signal of a second clock signal terminal CB, and “ot” denotes an output signal of an output signal terminal OT. It should be noted that 1 and 0 denote logic levels and are only for better explaining a specific work process of the embodiment of the disclosure, rather than voltage applied to the gate electrode of each transistor during specific implementation.

Specifically, illustration will be conducted with a case that a voltage value of a first reference signal vgl output by the first reference signal terminal VGL is a negative, a voltage value of a second reference signal vgh output by the second reference signal terminal VGH is positive and all the transistors are N-type transistors as instance. A first stage f1, a second stage f2, a third stage f3 and a fourth stage f4 in the signal timing diagram shown in FIG. 7 are selected. It should be noted that the signal timing diagram shown in FIG. 7 only shows a work process of a shift register unit in a current frame. Work processes of the shift register unit in other frames are basically the same as the work process of the shift register unit in the current frame, which will not repeated herein.

In the first stage f1, ip=1, ck=1, and cb=0.

Since the input signal ip provides a high level, the first clock signal ck provides a high level, and the second clock signal cb provides a low level, both the first transistor T1 and the third transistor T3 are turned on, and the fifth transistor T5 is turned off, the high level of the input signal ip is provided to the first node N1, the second transistor T2, the sixth transistor T6 and the eighth transistor T8 are all turned on, the high level of the first clock signal ck is provided to the third node N3, the fourth transistor T4 is turned on, the low level of the second clock signal cb is provided to the fourth node N4, a low level of a first reference signal vgl is provided to the second node N2, the seventh transistor T7 is turned off, and a high level of a second reference signal vgh is provided to the output signal terminal OT, such that the output signal terminal OT outputs a high level.

In the second stage f2, ip=0, ck=0, and cb=1.

Since the input signal ip provides a low level, the first clock signal ck provides a low level, and the second clock signal cb provides a high level, both the first transistor T1 and the third transistor T3 are turned off, and the fifth transistor T5 is turned on, the first node N1 maintains a high level, the second transistor T2, the sixth transistor T6 and the eighth transistor T8 are all turned on, the low level of the first clock signal ck is provided to the third node N3, the fourth transistor T4 is turned off, the second node N2 maintains the low level, the seventh transistor T7 is turned off, the low level of the second node N2 is provided to the fourth node N4, and a high level of a second reference signal vgh is provided to the output signal terminal OT, such that the output signal terminal OT outputs a high level.

In the third stage f3, ip=0, ck=1, and cb=0.

Since the input signal ip provides a low level, the first clock signal ck provides a high level, and the second clock signal cb provides a low level, both the first transistor T1 and the third transistor T3 are turned on, and the fifth transistor T5 is turned off, the low level of the input signal ip is provided to the first node N1, the second transistor T2, the sixth transistor T6 and the eighth transistor T8 are all turned off, the third node N3 is at a high level, the fourth transistor T4 is turned on, the low level of the second clock signal cb is provided for the fourth node N4, the second node N2 maintains a low level, and the seventh transistor T7 is turned off, such that the output signal terminal OT outputs a high level.

In the fourth stage f4, ip=0, ck=0, and cb=1.

Since the input signal ip provides a low level, the first clock signal ck provides a low level, and the second clock signal cb provides a high level, both the first transistor T1 and the third transistor T3 are turned off, and the fifth transistor T5 is turned on, the first node N1 maintains a low level, the second transistor T2, the sixth transistor T6 and the eighth transistor T8 are all turned off, the third node N3 maintains a high level, the fourth transistor T4 is turned on, the high level of the second clock signal cb is provided to the fourth node N4, the second node N2 is at a high level, the seventh transistor T7 is turned on, and a low level of a first reference signal vgl is provided to the output signal terminal OT, such that the output signal terminal OT outputs a low level.

It should be noted that in an illustrative embodiments shown in FIG. 6, potential of the third node N3 may be reduced from original 35 V to 17 V, such that a bias voltage environment of a related transistor is greatly reduced, and stability of the shift register unit is improved. The embodiments of the disclosure further provide yet another schematic structural diagram of a shift register unit. As shown in FIG. 8, implementations in the above embodiments are modified. Only differences between the embodiment and the above embodiments will be described below, and similarities will not be repeated herein.

In the embodiments of the disclosure, as shown in FIG. 8, the shift register unit further includes a voltage stabilizing circuit 40.

The voltage stabilizing circuit 40 is coupled to the third node N3, and is configured to maintain potential of the third node N3.

In an illustrative embodiment shown in FIG. 8, the voltage stabilizing circuit 40 includes a first capacitor C1.

A first electrode of the first capacitor C1 is coupled to the third node N3, and a second electrode of the first capacitor C1 is coupled to the second reference signal terminal VGH.

During specific implementation, the first capacitor C1 may maintain the potential of the third node N3, such that the stability of the voltage the third node N3 can be improved, and excessive bias voltage of the third node N3 can be effectively avoided.

In the embodiments of the disclosure, as shown in FIG. 8, the control signal terminal CT and the second reference signal terminal VGH are the same signal terminal.

For instance, the control signal terminal CT and the second reference signal terminal VGH may be coupled together, such that the number of signal lines can be reduced, and wiring difficulty can be reduced.

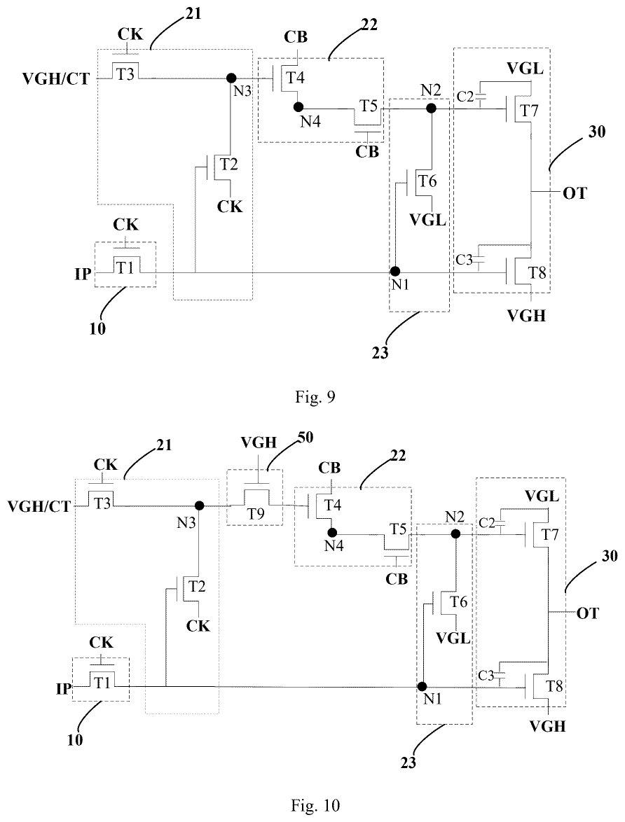

The embodiments of the disclosure further provide yet another schematic structural diagram of a shift register unit. As shown in FIG. 9, implementations in the above embodiments are modified. Only differences between the embodiment and the above embodiments will be described below, and similarities will not be repeated herein.

In the embodiments of the disclosure, as shown in FIG. 9, the control signal terminal CT and the second reference signal terminal VGH are the same signal terminal.

For instance, the control signal terminal CT and the second reference signal terminal VGH may be coupled together, such that the number of signal lines can be reduced, and wiring difficulty can be reduced.

The embodiments of the disclosure further provide yet another schematic structural diagram of a shift register unit. As shown in FIG. 10, implementations in the above embodiments are modified. Only differences between the embodiment and the above embodiments will be described below, and similarities will not be repeated herein.

In the embodiments of the disclosure, as shown in FIG. 10, the shift register unit further includes a protection circuit 50.

The third node N3 is coupled to the second control module 22 via the protection circuit 50. The protection circuit 50 is configured to control connection and disconnection between the third node N3 and the second control module 22.

In the embodiments of the disclosure, as shown in FIG. 10, the control signal terminal CT and the second reference signal terminal VGH are the same signal terminal.

For instance, the control signal terminal CT and the second reference signal terminal VGH may be coupled together, such that the number of signal lines can be reduced, and wiring difficulty can be reduced.

In the embodiments of the disclosure, as shown in FIG. 10, the protection circuit 50 includes a ninth transistor T9.

A gate electrode of the ninth transistor T9 is coupled to the second reference signal terminal VGH, a first electrode of the ninth transistor T9 is coupled to the gate electrode of the fourth transistor T4, and a second electrode of the ninth transistor T9 is coupled to the third node N3.

During specific implementation, the ninth transistor T9 may be turned on under control of an effective level of a second reference signal provided by the second reference signal terminal VGH, and may be turned off under control of an ineffective level of the second reference signal. For instance, if the ninth transistor T9 is set as an N-type transistor, the effective level of the second reference signal is a high level, and the ineffective level of the second reference signal is a low level. When the ninth transistor T9 is in an on state, the gate electrode of the fourth transistor T4 may be connected to the third node N3. When the ninth transistor T9 is in an off state, the gate electrode of the fourth transistor T4 may be disconnected from the third node N3.

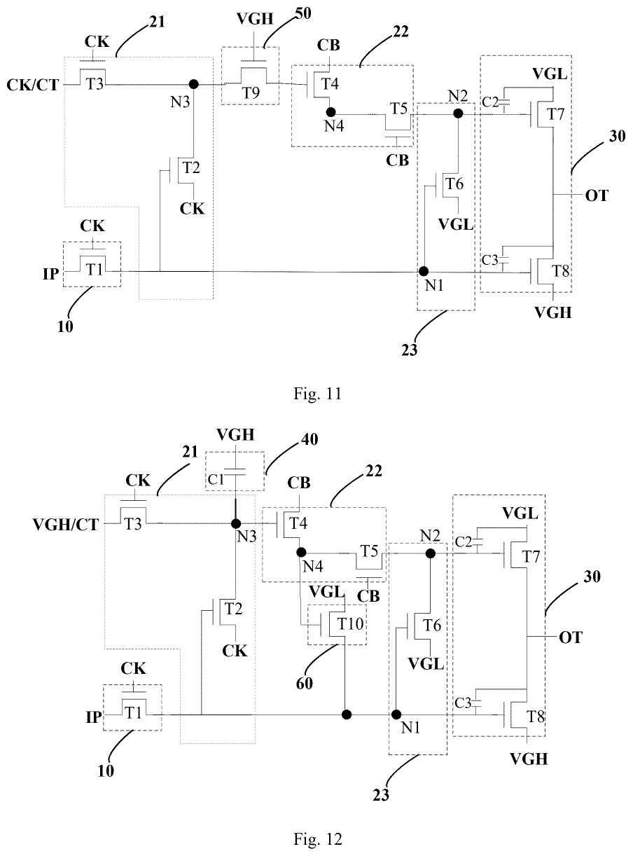

The embodiments of the disclosure further provide yet another schematic structural diagram of a shift register unit. As shown in FIG. 11, implementations in the above embodiments are modified. Only differences between the embodiment and the above embodiments will be described below, and similarities will not be repeated herein.

In the embodiments of the disclosure, as shown in FIG. 11, the shift register unit further includes a protection circuit 50.

The third node N3 is coupled to the second control module 22 via the protection circuit 50. The protection circuit 50 is configured to control connection and disconnection between the third node N3 and the second control module 22.

In the embodiments of the disclosure, as shown in FIG. 11, the control signal terminal CT and the first clock signal terminal CK are the same signal terminal.

For instance, the control signal terminal CT and the first clock signal terminal CK may be coupled together, such that the number of signal lines can be reduced, and wiring difficulty can be reduced.

In the embodiments of the disclosure, as shown in FIG. 11, the protection circuit 50 includes a ninth transistor T9.

A gate electrode of the ninth transistor T9 is coupled to the second reference signal terminal VGH, a first electrode of the ninth transistor T9 is coupled to the gate electrode of the fourth transistor T4, and a second electrode of the ninth transistor T9 is coupled to the third node N3.

During specific implementation, the ninth transistor T9 may be turned on under control of an effective level of a second reference signal provided by the second reference signal terminal VGH, and may be turned off under control of an ineffective level of the second reference signal. For instance, if the ninth transistor T9 is set as an N-type transistor, the effective level of the second reference signal is a high level, and the ineffective level of the second reference signal is a low level. When the ninth transistor T9 is in an on state, the gate electrode of the fourth transistor T4 may be connected to the third node N3. When the ninth transistor T9 is in an off state, the gate electrode of the fourth transistor T4 may be disconnected from the third node N3.

The embodiments of the disclosure further provide yet another schematic structural diagram of a shift register unit. As shown in FIG. 12, implementations in the above embodiments are modified. Only differences between the embodiment and the above embodiments will be described below, and similarities will not be repeated herein.

In the embodiments of the disclosure, as shown in FIG. 12, the shift register unit further includes a voltage stabilizing circuit 40.

The voltage stabilizing circuit 40 is coupled to the third node N3, and is configured to maintain potential of the third node N3.

In the embodiments of the disclosure, as shown in FIG. 12, the voltage stabilizing circuit 40 includes a first capacitor C1.

A first electrode of the first capacitor C1 is coupled to the third node N3, and a second electrode of the first capacitor C1 is coupled to the second reference signal terminal VGH.

During specific implementation, the first capacitor C1 may maintain the potential of the third node N3, such that the stability of the voltage of the third node N3 can be improved, and excessive bias voltage of the third node N3 can be effectively avoided.

In the embodiments of the disclosure, as shown in FIG. 12, the shift register unit further includes a reset circuit 60.

The reset circuit 60 is coupled to the first node N1 and a fourth node N4, and is configured to provide the signal of the first reference signal terminal VGL to the first node N1 in response to a signal of the fourth node N4.

In the embodiments of the disclosure, as shown in FIG. 12, the reset circuit 60 includes a tenth transistor T10.

A gate electrode of the tenth transistor T10 is coupled to the fourth node N4, a first electrode of the tenth transistor T10 is coupled to the first node N1, and a second electrode of the tenth transistor T10 is coupled to the first reference signal terminal VGL.

During specific implementation, the tenth transistor T10 is turned on under control of the effective level of the signal transmitted by the fourth node N4, and is turned off under control of the ineffective level of the signal transmitted by the fourth node N4. For instance, if the tenth transistor T10 is set as an N-type transistor, the effective level of the signal transmitted by the fourth node N4 is a high level, and the ineffective level of the signal transmitted by the fourth node N4 is a low level. When the tenth transistor T10 is in an on state, the first node N1 may be connected to the first reference signal terminal VGL. When the tenth transistor T10 is in an off state, the first node N1 may be disconnected from the first reference signal terminal VGL.

What are described above only illustrate a specific structure of the shift register unit according to the embodiments of the disclosure. During specific implementation, specific structures of the above circuits are not limited to the above structures provided in the embodiments of the disclosure, and may also be other structures known to those skilled in the art, which are not limited herein.

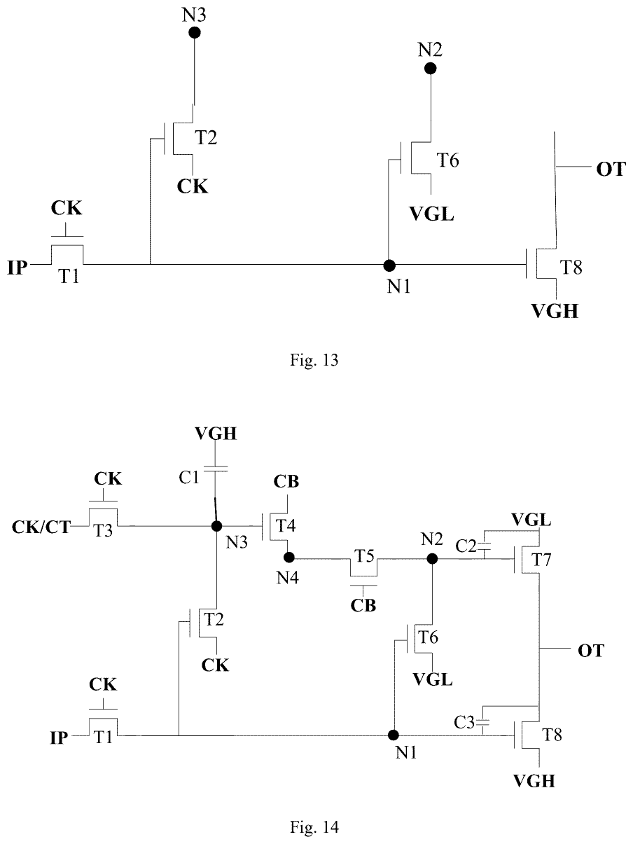

Based on the same disclosed concept, as shown in FIGS. 13-17, the embodiments of the disclosure further provide a shift register unit. The shift register unit includes:
a first transistor T1, where a first electrode of the first transistor T1 is directly connected to a first node N1;
a second transistor T2, where a gate electrode of the second transistor T2 is directly connected to the first node N1, and a second electrode of the second transistor T2 is coupled to a third node N3;
a sixth transistor T6, where a gate electrode of the sixth transistor T6 is directly connected to the first node N1, and a second electrode of the sixth transistor T6 is coupled to a second node N2; and
an eighth transistor T8, where a gate electrode of the eighth transistor T8 is directly connected to the first node N1, a first electrode of the eighth transistor T8 is coupled to a second reference signal terminal VGH, and a second electrode of the eighth transistor T8 is coupled to an output signal terminal OT.

The first node N1 is not controlled by the second node N2 or the third node N3.

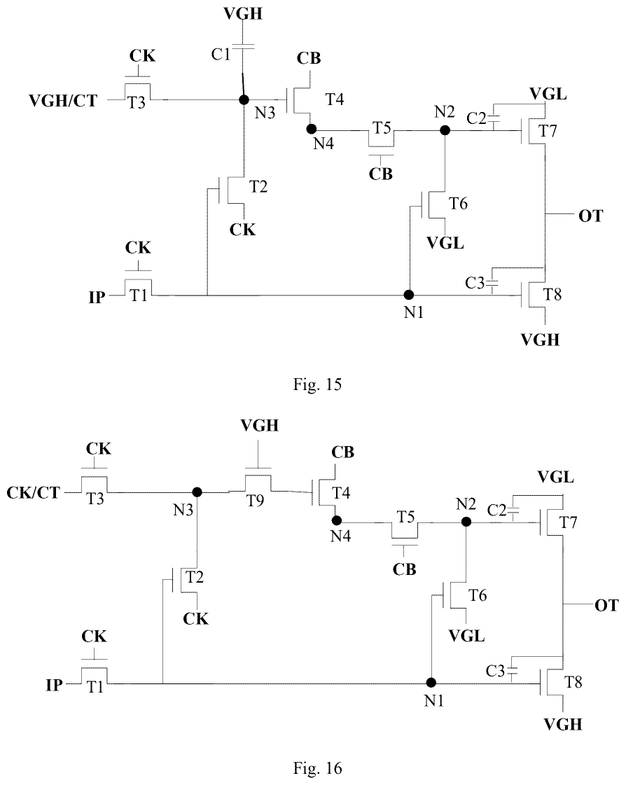

In the illustrative embodiments shown in FIGS. 14 and 15, the shift register unit further includes:
a first capacitor C1, where a first electrode of the first capacitor C1 is coupled to the third node N3, and a second electrode of the first capacitor C1 is coupled to the second reference signal terminal VGH.

In the embodiments of the disclosure, as shown in FIGS. 14 and 15, the shift register unit further includes:
a third transistor T3, where a first electrode of the third transistor T3 is coupled to the third node N3, and a second electrode of the third transistor T3 is coupled to a control signal terminal CT;
a fourth transistor T4, where a gate electrode of the fourth transistor T4 is coupled to the third node N3, and a first electrode of the fourth transistor T4 is coupled to a fourth node N4;
a fifth transistor T5, where a first electrode of the fifth transistor T5 is coupled to the second node N2, and a second electrode of the fifth transistor T5 is coupled to the fourth node N4;
a seventh transistor T7, where a gate electrode of the seventh transistor T7 is coupled to the second node N2, and a first electrode of the seventh transistor T7 is coupled to the output signal terminal OT;
a second capacitor C2, where a first electrode of the second capacitor C2 is coupled to the second node N2, and a second electrode of the second capacitor C2 is coupled to a first reference signal terminal VGL; and
a third capacitor C3, where a first electrode of the third capacitor C3 is coupled to the first node N1, and a second electrode of the third capacitor C3 is coupled to the output signal terminal OT.

In the embodiments of the disclosure, as shown in FIGS. 14 and 15, a gate electrode of the first transistor T1 is coupled to a first clock signal terminal CK, and a second electrode of the first transistor T1 is coupled to an input signal terminal IP;
a first electrode of the second transistor T2 is coupled to the first clock signal terminal CK;
a gate electrode of the third transistor T3 is coupled to the first clock signal terminal CK.
a second electrode of the fourth transistor T4 is coupled to a second clock signal terminal CB;
a gate electrode of the fifth transistor T5 is coupled to the second clock signal terminal CB.
a first electrode of the sixth transistor T6 is coupled to the first reference signal terminal VGL;
a second electrode of the seventh transistor T7 is coupled to the first reference signal terminal VGL; and
a second electrode of the eighth transistor T8 is coupled to the output signal terminal OT.

In the embodiments of the disclosure, as shown in FIG. 14, the control signal terminal CT and the first clock signal terminal CK are the same signal terminal.

In the embodiments of the disclosure, as shown in FIG. 15, the control signal terminal CT and the second reference signal terminal VGH are the same signal terminal.

In the embodiments of the disclosure, as shown in FIG. 16, the shift register unit further includes a ninth transistor T9.

A gate electrode of the ninth transistor T9 is coupled to the second reference signal terminal VGH, and a second electrode of the ninth transistor T9 is coupled to the third node N3.

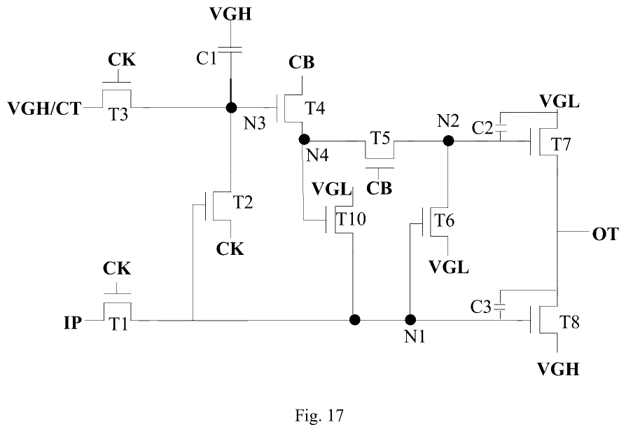

In the embodiments of the disclosure, as shown in FIG. 17, the shift register unit further includes a tenth transistor T10.

A gate electrode of the tenth transistor T10 is coupled to a fourth node N4, a first electrode of the tenth transistor T10 is coupled to the first node N1, and a second electrode of the tenth transistor T10 is coupled to a first reference signal terminal VGL.

What are described above only illustrate a specific structure of the shift register unit according to the embodiments of the disclosure. During specific implementation, specific structures of the above circuits are not limited to the above structures provided in the embodiments of the disclosure, and may also be other structures known to those skilled in the art, which are not limited herein.

In a specific implementation process, a problem solving principle of the shift register unit is similar to that of the above shift register unit, so reference may be made to part of the above description for implementation of the shift register unit, which is not repeated herein.

Based on the same disclosed concept, the embodiments of the disclosure further provides a drive control circuit, which includes a plurality of cascaded shift register units. An input signal terminal of a first stage shift register unit is coupled to a frame triggering signal terminal. In every two adjacent shift register units, an input signal terminal of a next stage shift register unit is coupled to an output signal terminal of a previous stage shift register unit.

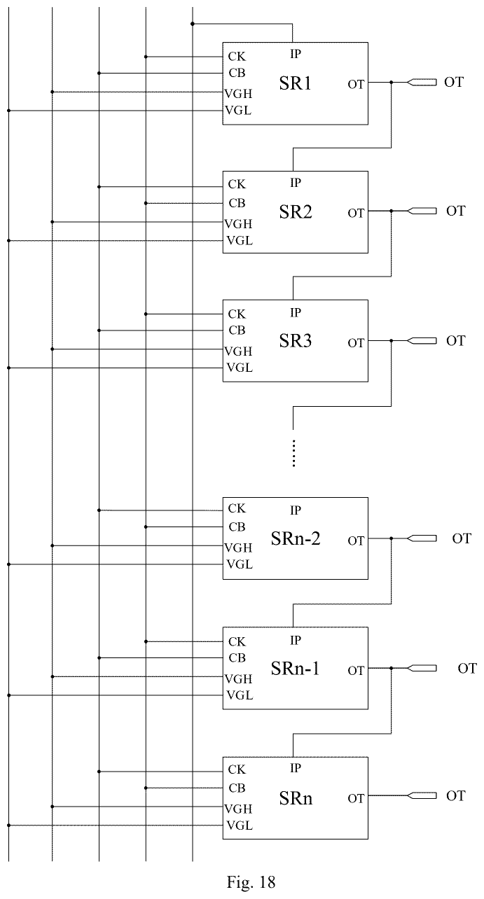

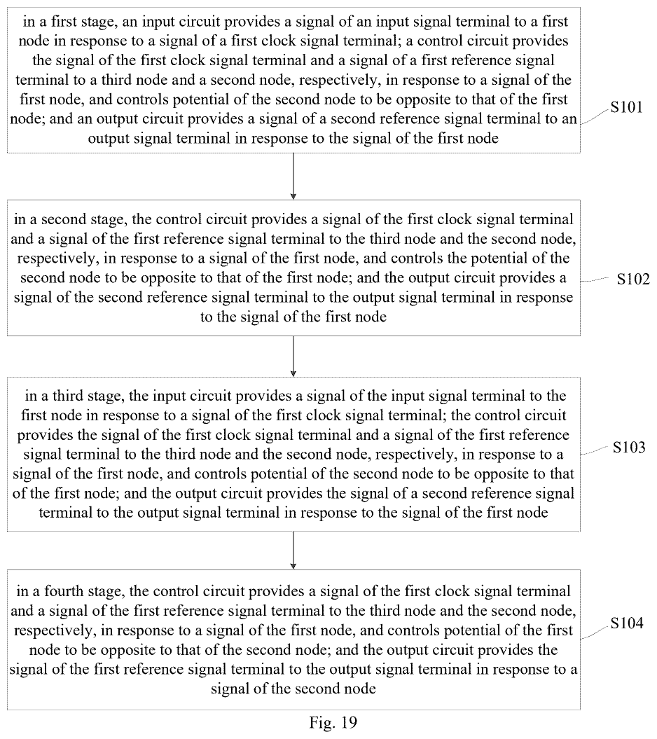

For instance, as shown in FIG. 18, the drive control circuit includes a plurality of cascaded shift register units SR1, SR2, SR3 . . . SRn-2, SRn-1, and SRn, where n is a natural number greater than 6. A value of n depends on actual design needs. The shift register unit may be the shift register unit shown in an instance of FIG. 6. Each shift register unit includes an input signal terminal, an output signal terminal, a first clock signal terminal, and a second clock signal terminal. Each end point is accessed by signals marked in the timing diagram shown in FIG. 7 as follows: an input signal terminal of a shift register unit SR1 is coupled to a frame triggering signal terminal, stv represents a frame triggering signal provided by the frame triggering signal terminal, and an output signal terminal of a previous stage shift register unit is coupled to an input signal terminal of a next stage shift register unit in the other shift register units. That is, a signal output by the output signal terminal of the shift register unit SR1 may be used as a signal of an input signal terminal of a shift register unit SR2, a signal output by an output signal terminal of a shift register unit SR2 may be used as a signal of an input signal terminal of a shift register unit SR3 . . . , and a signal of an output signal terminal of a shift register unit SRn-1 may be used as a signal of an input signal terminal of a shift register unit SRn until no next stage of shift register unit exists. A first clock signal is input to a first clock signal terminal, and a second clock signal is input to a second clock signal terminal. The timing of other drive control circuits may be inferred according to a connection relation of all shift register units and the timing shown in FIG. 7, which will not be repeated herein. The drive control circuit may be configured in a liquid crystal display panel or an electroluminescent display panel, which is not limited herein.

Specifically, a specific structure of each shift register unit in the drive control circuit has the same function and structure as the shift register unit of the disclosure, which will not be repeated herein. The drive control circuit may be configured in a liquid crystal display panel or an electroluminescent display panel, which is not limited herein.

Based on the same disclosed concept, the embodiments of the disclosure further provide a display apparatus, which includes the above drive control circuit according to the embodiments of the disclosure. A problem solving principle of the display apparatus is similar to that of the drive control circuit, so the implementation of the display apparatus can be referred to the implementation of the above drive control circuit, which will not be repeated herein.

During specific implementation, in the embodiments of the disclosure, the display apparatus may be any product or component having a display function, such as a mobile phone, a tablet computer, a television, a display screen, a notebook computer, a digital photo frame, and a navigator. Other essential components of the display apparatus should be understood by those of ordinary skill in the art, which are not repeated herein and should not limit the disclosure.

During specific implementation, the display apparatus may include a plurality of pixel units, a plurality of gate lines, and data lines. Each pixel unit may include a plurality of sub-pixels, such as red sub-pixels, green sub-pixels, and blue sub-pixels. The display apparatus according to the embodiments of the disclosure may be an organic light emitting display apparatus or a liquid crystal display apparatus, which is not limited herein.

In the embodiments of the disclosure, the display apparatus includes a plurality of scanning lines. The plurality of scanning lines are further correspondingly provided with drive control circuits. One scanning line is electrically connected with an output signal terminal of one shift register unit in the drive control circuit. For instance, when the display apparatus according to the embodiments of the disclosure is a liquid crystal display apparatus, a TFT in a sub-pixel may be electrically connected with a scanning line, the drive control circuit may be used as a gate drive circuit, and the gate drive circuit is electrically connected with the scanning line, so as to provide a gate scanning signal for the TFT in the sub-pixel. It should be noted that the TFT in the sub-pixel may be an N-type transistor or a P-type transistor, which is not limited herein.

In the embodiments of the disclosure, the display apparatus includes a plurality of light emitting control signal lines and a plurality of scanning lines. The plurality of light emitting control signal lines are correspondingly provided with drive control circuits. One light emitting control signal line is electrically connected with an output signal terminal of one shift register unit in the drive control circuit. In addition, the plurality of scanning lines are also correspondingly provided with drive control circuits. One scanning line is electrically connected to an output signal terminal of one shift register unit in the drive control circuit. For instance, an organic light emitting display apparatus is generally provided with a plurality of organic light emitting diodes and pixel circuits connected to the organic light emitting diodes. The pixel circuit is generally provided with a light emitting control transistor configured to control the organic light emitting diode to emit light and a scanning control transistor configured to control the input of a data signal.

During specific implementation, when the display apparatus according to the embodiments of the disclosure is the organic light emitting display apparatus, the light emitting control transistor may be electrically connected with the light emitting control signal line, the scanning control transistor may be electrically connected with the scanning line, and the organic light emitting display apparatus may include the drive control circuit according to the embodiments of the disclosure. The drive control circuit may be used as a light emitting drive circuit, and the light emitting drive circuit is electrically connected with the light emitting control transistor and configured to provide a light emitting control signal of the light emitting control transistor; or the drive control circuit may be used as a gate drive circuit, and the gate drive circuit is electrically connected with the scanning line and configured to provide a gate scanning signal of the scanning control transistor. Certainly, the organic light emitting display apparatus may also include the two drive control circuits according to the embodiments of the disclosure. One of the drive control circuits may be used as the light emitting drive circuit, and is electrically connected with the light emitting control transistor and configured to provide the light emitting control signal of the light emitting control transistor; and the other one of the drive control circuits may be used as the gate drive circuit, and is electrically connected with the scanning line and configured to provide the gate scanning signal of the scanning control transistor, which is not limited herein.

Based on the same disclosed concept, as shown in FIG. 19, the embodiments of the disclosure further provide a drive method for the shift register unit. The drive method includes the following step.
S101: in a first stage, an input circuit provides a signal of an input signal terminal to a first node in response to a signal of a first clock signal terminal; a control circuit provides the signal of the first clock signal terminal and a signal of a first reference signal terminal to a third node and a second node, respectively, in response to a signal of the first node, and controls potential of the second node to be opposite to that of the first node; and an output circuit provides a signal of a second reference signal terminal to an output signal terminal in response to the signal of the first node.

In the embodiments of the disclosure, as shown in FIG. 19, after the first stage, the drive method further includes the following steps.
S102: in a second stage, the control circuit provides a signal of the first clock signal terminal and a signal of the first reference signal terminal to the third node and the second node, respectively, in response to a signal of the first node, and controls the potential of the second node to be opposite to that of the first node; and the output circuit provides a signal of the second reference signal terminal to the output signal terminal in response to the signal of the first node.
S103: in a third stage, the input circuit provides a signal of the input signal terminal to the first node in response to a signal of the first clock signal terminal; the control circuit provides the signal of the first clock signal terminal and a signal of the first reference signal terminal to the third node and the second node, respectively, in response to a signal of the first node, and controls potential of the second node to be opposite to that of the first node; and the output circuit provides the signal of a second reference signal terminal to the output signal terminal in response to the signal of the first node.
S104: in a fourth stage, the control circuit provides a signal of the first clock signal terminal and a signal of the first reference signal terminal to the third node and the second node, respectively, in response to a signal of the first node, and controls potential of the first node to be opposite to that of the second node; and the output circuit provides the signal of the first reference signal terminal to the output signal terminal in response to a signal of the second node.

The drive method has the same drive principle and specific implementation as the shift register unit in the embodiments, so reference may be made to specific implementation of the shift register unit in the embodiment for the drive method, which will not be repeated herein.

According to the shift register unit, the drive control circuit, the display apparatus and the drive method provided by the embodiments of the disclosure, the input circuit controls the signal of the first node; the control circuit controls the signal of the second node and the signal of the third node, and the signal of the second node or the third node does not influence the signal of the first node; and the output circuit controls the signal of the output signal terminal. The number of devices used in the entire shift register unit is small, circuit complexity is low, production cost is low, a circuit structure is simple, and an occupied area is small, which facilitate narrow frame design. Moreover, through mutual cooperation of the above devices, the stability of the signal output by the output signal terminal can be improved.

Although preferred embodiments of the disclosure are described, those skilled in the art can still make additional changes and modifications to the embodiments once they learn the basic inventive concept. Therefore, the appended claims are intended to be interpreted as including the preferred embodiments and all changes and modifications falling within the scope of the disclosure.

Apparently, those skilled in the art can make various modifications and variations to the disclosure without departing from the spirit and scope of the disclosure. In this way, if the modifications and variations of the disclosure fall within the scope of the claims of the disclosure and their equivalent technologies, the disclosure is also intended to include the modifications and variations.

1. A shift register unit, comprising:
an input circuit, coupled to a first node and configured to provide, in response to a signal of a first clock signal terminal, a signal of an input signal terminal to the first node;
a control circuit, coupled to the first node, a second node, a control signal terminal, and a first reference signal terminal and configured to provide, in response to a signal of the first node, the signal of the first clock signal terminal and a signal of the first reference signal terminal to a third node and the second node, respectively, wherein the first node is not controlled by the second node or the third node; and
an output circuit, coupled to the first node and the second node and configured to provide, in response to a signal of the second node, the signal of the first reference signal terminal to an output signal terminal and to provide, in response to the signal of the first node, a signal of a second reference signal terminal to the output signal terminal.

2. The shift register unit according to claim 1, wherein the control circuit comprises a first control module, a second control module, and a third control module;
the first control module is coupled to the first node and the third node, and is configured to provide, in response to the signal of the first node, the signal of the first clock signal terminal to the third node and to provide, in response to the signal of the first clock signal terminal, a signal of the control signal terminal to the third node;
the second control module is coupled to the second node and the third node, and is configured to provide, in response to a signal of the third node and a signal of a second clock signal terminal, the signal of the second clock signal terminal to the second node; and
the third control module is coupled to the first node and the second node, and is configured to provide, in response to the signal of the first node, the signal of the first reference signal terminal to the second node.

3. The shift register unit according to claim 1, further comprising a voltage stabilizing circuit,
wherein the voltage stabilizing circuit is coupled to the third node, and is configured to maintain potential of the third node; and
wherein the voltage stabilizing circuit comprises a first capacitor; and a first electrode of the first capacitor is coupled to the third node, and a second electrode of the first capacitor is coupled to the second reference signal terminal.

4. (canceled)

5. (canceled)

6. The shift register unit according to claim 1, wherein the control signal terminal and the first clock signal terminal are a same signal terminal; or
wherein the control signal terminal and the second reference signal terminal are a same signal terminal.

7. (canceled)

8. The shift register unit according to claim 1, wherein the input circuit comprises a first transistor; and
a gate electrode of the first transistor is coupled to the first clock signal terminal, a first electrode of the first transistor is coupled to the first node, and a second electrode of the first transistor is coupled to the input signal terminal.

9. The shift register unit according to claim 2, wherein the first control module comprises a second transistor and a third transistor;
a gate electrode of the second transistor is coupled to the first node, a first electrode of the second transistor is coupled to the first clock signal terminal, and a second electrode of the second transistor is coupled to the third node; and
a gate electrode of the third transistor is coupled to the first clock signal terminal, a first electrode of the third transistor is coupled to the third node, and a second electrode of the third transistor is coupled to the control signal terminal.

10. The shift register unit according to claim 2, wherein the second control module comprises a fourth transistor and a fifth transistor;
a gate electrode of the fourth transistor is coupled to the third node, a first electrode of the fourth transistor is coupled to a fourth node, and a second electrode of the fourth transistor is coupled to the second clock signal terminal; and
a gate electrode of the fifth transistor is coupled to the second clock signal terminal, a first electrode of the fifth transistor is coupled to the second node, and a second electrode of the fifth transistor is coupled to the fourth node.

11. (canceled)

12. The shift register unit according to claim 2, wherein the third control module comprises a sixth transistor; and
a gate electrode of the sixth transistor is coupled to the first node, a first electrode of the sixth transistor is coupled to the first reference signal terminal, and a second electrode of the sixth transistor is coupled to the second node.

13. The shift register unit according to claim 1, wherein the output circuit comprises a seventh transistor, a second capacitor, an eighth transistor, and a third capacitor;
a gate electrode of the seventh transistor is coupled to the second node, a first electrode of the seventh transistor is coupled to the output signal terminal, and a second electrode of the seventh transistor is coupled to the first reference signal terminal;
a first electrode of the second capacitor is coupled to the second node, and a second electrode of the second capacitor is coupled to the first reference signal terminal;
a gate electrode of the eighth transistor is coupled to the first node, a first electrode of the eighth transistor is coupled to the second reference signal terminal, and a second electrode of the eighth transistor is coupled to the output signal terminal; and
a first electrode of the third capacitor is coupled to the first node, and a second electrode of the third capacitor is coupled to the output signal terminal.

14. The shift register unit according to claim 2, further comprising a protection circuit,
wherein the third node is coupled to the second control module via the protection circuit, and the protection circuit is configured to control connection and disconnection between the third node and the second control module;
wherein the protection circuit comprises a ninth transistor; and
a gate electrode of the ninth transistor is coupled to the second reference signal terminal, a first electrode of the ninth transistor is coupled to a gate electrode of a fourth transistor, and a second electrode of the ninth transistor is coupled to the third node.

15. The shift register unit according to claim 1, further comprising a reset circuit,
wherein the reset circuit is coupled to the first node and a fourth node, and is configured to provide, in response to a signal of the fourth node, the signal of the first reference signal terminal to the first node;
wherein the reset circuit comprises a tenth transistor; and
a gate electrode of the tenth transistor is coupled to the fourth node, a first electrode of the tenth transistor is coupled to the first node, and a second electrode of the tenth transistor is coupled to the first reference signal terminal.

16. A shift register unit, comprising:
a first transistor, wherein a first electrode of the first transistor is directly connected to a first node;
a second transistor, wherein a gate electrode of the second transistor is directly connected to the first node, and a second electrode of the second transistor is coupled to a third node;
a sixth transistor, wherein a gate electrode of the sixth transistor is directly connected to the first node, and a second electrode of the sixth transistor is coupled to a second node; and
an eighth transistor, wherein a gate electrode of the eighth transistor is directly connected to the first node, a first electrode of the eighth transistor is coupled to a second reference signal terminal, and a second electrode of the eighth transistor is coupled to an output signal terminal, wherein
the first node is not controlled by the second node or the third node.

17. The shift register unit according to claim 16, further comprising:
a first capacitor, wherein a first electrode of the first capacitor is coupled to the third node, and a second electrode of the first capacitor is coupled to the second reference signal terminal.

18. The shift register unit according to claim 16, further comprising a ninth transistor and a tenth transistor, wherein
a gate electrode of the ninth transistor is coupled to the second reference signal terminal, and a second electrode of the ninth transistor is coupled to the third node; and
a gate electrode of the tenth transistor is coupled to a fourth node, a first electrode of the tenth transistor is coupled to the first node, and a second electrode of the tenth transistor is coupled to a first reference signal terminal.

19. (canceled)

20. The shift register unit according to claim 16, further comprising:
a third transistor, wherein a first electrode of the third transistor is coupled to the third node, and a second electrode of the third transistor is coupled to a control signal terminal;
a fourth transistor, wherein a gate electrode of the fourth transistor is coupled to the third node, and a first electrode of the fourth transistor is coupled to a fourth node;
a fifth transistor, wherein a first electrode of the fifth transistor is coupled to the second node, and a second electrode of the fifth transistor is coupled to the fourth node;
a seventh transistor, wherein a gate electrode of the seventh transistor is coupled to the second node, and a first electrode of the seventh transistor is coupled to the output signal terminal;
a second capacitor, wherein a first electrode of the second capacitor is coupled to the second node, and a second electrode of the second capacitor is coupled to a first reference signal terminal; and
a third capacitor, wherein a first electrode of the third capacitor is coupled to the first node, and a second electrode of the third capacitor is coupled to the output signal terminal.

21. The shift register unit according to claim 20, wherein
a gate electrode of the first transistor is coupled to a first clock signal terminal, and a second electrode of the first transistor is coupled to an input signal terminal;
a first electrode of the second transistor is coupled to the first clock signal terminal;
a gate electrode of the third transistor is coupled to the first clock signal terminal;
a second electrode of the fourth transistor is coupled to a second clock signal terminal;
a gate electrode of the fifth transistor is coupled to the second clock signal terminal;
a first electrode of the sixth transistor is coupled to the first reference signal terminal;
a second electrode of the seventh transistor is coupled to the first reference signal terminal; and
a second electrode of the eighth transistor is coupled to the output signal terminal.

22. The shift register unit according to claim 21, wherein the control signal terminal and the first clock signal terminal are a same signal terminal; or
wherein the control signal terminal and the second reference signal terminal are a same signal terminal.

23. (canceled)

24. A drive control circuit, comprising:
a plurality of cascaded shift register units according to claim 1, wherein
an input signal terminal of a first stage shift register unit is coupled to a frame triggering signal terminal; and
in every two adjacent shift register units, an input signal terminal of a next stage shift register unit is coupled to an output signal terminal of a previous stage shift register unit.

25. A display apparatus, comprising:
the drive control circuit according to claim 24.

26. A drive method for the shift register unit according to claim 1, comprising:
in a first stage, providing, by an input circuit, a signal of an input signal terminal to a first node in response to a signal of a first clock signal terminal; providing, by a control circuit, the signal of the first clock signal terminal and a signal of a first reference signal terminal to a third node and a second node, respectively, in response to a signal of the first node, and controlling potential of the second node to be opposite to potential of the first node; and providing, by an output circuit, a signal of a second reference signal terminal to an output signal terminal in response to the signal of the first node.
